(19) United States
(12) Patent Application Publication
(10) Pub. No.: US 2025/0187210 A1
(43) Pub. Date: Jun. 12, 2025

(54) APPARATUS FOR HANDLING ARTICLES AND METHOD FOR REGENERATING A SUCTION SURFACE OF A GRIPPING DEVICE

(71) Applicant: Krones Aktiengesellschaft, Neutraubling (DE)

(72) Inventors: Thomas HENSEL, Aying (DE); Johannes KIRZINGER, München (DE); Dominik OBERHOLZNER, Brannenburg (DE)

(21) Appl. No.: 18/966,710

(22) Filed: Dec. 3, 2024

(30) Foreign Application Priority Data
Dec. 7, 2023 (DE) 10 2023 134 354.8

(51) Int. Cl. B25J 19/00; B25J 15/06; F26B 3/06; F26B 25/20

(52) U.S. Cl. CPC B25J 19/0066; B25J 15/0691; F26B 3/06; F26B 25/20

(57) ABSTRACT

The invention relates to an apparatus (10) and a method for handling articles (11). The apparatus (10) comprises a gripping device (14) with a suction surface (16) that can be subjected to negative pressure for grasping the articles (11) by suction. The suction surface (16) is covered with a layer (24) that is elastically deformable and air-permeable, at least in certain regions.

The apparatus (10) is also equipped with a drying device (32), which drying device can interact with the layer (24) that is attached to the suction surface (16) or forms the suction surface (16), in order to remove moisture that is bound or adhering therein.

### CLAIM OF PRIORITY

The present application claims priority to German Application DE 10 2023 134 354.8 filed Dec. 7, 2023, which is incorporated by reference.

### FIELD OF THE INVENTION

The present invention relates to an apparatus for handling articles and a method for regenerating a suction surface of a gripping device.

### BACKGROUND OF THE INVENTION

The present invention relates to an apparatus and a method for handling articles, in particular prior to further processing, for example prior to filling and closing containers such as empty cans. Such an apparatus can, for example, find its practical application in the beverage industry.

In the production of beverage cans, for example, the empty cans used for this purpose are normally delivered as new container cans on pallet layers and prepared for further processing. The new container cans are empty cans without top lids. In the following, in each instance the term “empty cans” is used in this context, while the pallet layers can also be referred to as empty can layers.

As a rule, a plurality of layers of empty cans are arranged in a manner stacked on top of one another on a pallet, wherein an intermediate layer made of a flat material, for example a paper layer, a thin plastics material layer, a cardboard intermediate layer or the like, in each instance can be arranged between the layers of empty cans stacked on top of one another.

The empty can layers can be grasped in their entirety by a gripping device and pushed onto a transport device, in order to feed them for further processing. Further processing refers in particular to filling the empty cans and closing them on their upper side by positioning a can lid.

Layer grippers can also be used which have a foam surface that can be subjected to negative pressure. By sucking in air in this way, the empty cans can also be sucked in and held on the layer gripper. The foam surface is positioned on the empty can layer and the foam is formed and equipped in such a way that preferably no or little ambient air is sucked in if the empty cans are sucked in and lifted by applying a negative pressure.

This repacking along with the loading and unloading of empty cans is accompanied by the formation of condensation, which is partly due to the temperature differences in the system. The formation of condensation, which is unavoidable in many cases, is accompanied by handling problems, since the foam surfaces react sensitively to penetrating moisture. Added to this are hygiene problems due to the inevitable promotion of the formation of germs in the increasingly humid environment of the foam layers used.

Such problems can generally occur with suction pads that are used in the packaging industry, including those that serve to handle other containers, packaging units, packaging materials such as film, cardboard and the like.

The primary objective of the present invention can be seen in providing an improved and reliably operating handling apparatus for handling articles such as empty cans, which operates with consistent reliability even under adverse conditions and after prolonged operating times. In addition, a method is to be provided for maintaining and, as required, restoring the desired operating conditions, which method can also be used to counter emerging hygiene risks.

The objectives are achieved with the subjects of the independent claims. Features of advantageous configurations and further developments of the invention are apparent in the respective dependent claims.

### SUMMARY OF THE INVENTION

In order to achieve at least some of the above-mentioned objectives, the invention proposes an apparatus having the features of the independent claim, which can serve in particular for handling articles such as empty cans.

The apparatus according to the invention comprises a gripping device with a suction surface for grasping the articles by suction. The entire suction surface or defined partial regions of the suction surface can be subjected to negative pressure, in order to be able to suck in, grasp and lift the articles in this way. In addition, the suction surface is covered with an elastically deformable layer that is air-permeable, at least in certain regions. The apparatus is equipped with a drying device or can be at least temporarily coupled with a drying device. This drying device is provided and appropriately equipped or configured in order to interact with the layer that is attached to or forms the suction surface, namely in order to at least partially remove moisture that is bound or adhering therein.

The term “suction surface” used here and generally in the present is intended to refer in particular to a suction region of the gripping device that comes into contact with the articles to be grasped and brought into adhesion to the suction surface by negative pressure. This suction region, substantially formed by the suction surface, can optionally also be regarded as the suction region, the contact surface or the effective region of the gripping device to which negative pressure can be applied and can be designated as such.

The term “articles” used here, which are handled by the apparatus according to the invention with the aid of its gripping device, can in principle refer to a wide variety of objects, packaging units, containers, etc., which are to be grasped by suction. Typically, here a large number of similar articles are grasped at the same time, such as those in a pallet layer or a palletized layer.

In principle, such suction plate grippers, as which the gripping apparatus according to the invention can be regarded or described, can be used for grasping very different articles by the application of negative pressure, for example for flat packaging materials, e.g., for intermediate layers made of cardboard material, plastics material or wood, or cellulose-containing materials. Optionally, such suction plate grippers of the gripping apparatus according to the invention can also be used for grasping containers of all kinds or packaging units, packs or pallet layers by the application of negative pressure.

A useful application for such a suction plate gripper or for the apparatus according to the invention can also be the grasping and handling of cans, in particular empty cans, but optionally also of filled cans, in each instance equipped with a lid and sealed. The term “empty cans,” used here and in other places in the present description, which can be handled by the apparatus according to the invention with the aid of its gripping apparatus, refers in the present context in particular to metal beverage containers or beverage containers made of sheet metal in the form of cans with openings on their upper side, which cans generally have a hollow cylindrical shape with a bottom surface that, on its end face, is flat or concavely curved in portions. When not yet filled with liquid contents such as a beverage, the flat top lid can still be partially or completely missing. The hollow cylindrical shape of such cans can be produced in particular by a deep-drawing process for the plastic forming of sheet metal portions, unless they are plastics material cans or cans made of a composite material.

Therefore, if reference is made in the present context to empty cans to be handled with openings on their upper side, this normally refers to empty cans in a raw state that are to be handled in large numbers prior to their respective filling with liquid contents and prior to their respective airtight sealing by placing a lid on their upper side, which can involve, for example, grouping, repositioning, destacking, depalletizing or the like. It is also possible to regroup or stack the empty boxes in this context.

The lids to be placed on the cans after they are filled can be positioned there and preferably applied to the upper end faces of the respective cans by a sealing flared joint, after which the cans, now filled and sealed in this way, may be subjected to further treatment and/or handling steps, which, however, are not of particular interest in the present context.

Such further treatment steps can comprise, for example, printing on the casing side or attaching printed labels. Further handling steps refer in particular to grouping, bundling and packaging processes, since a plurality of cans are often combined to form packs before large packs or pallet layers are formed therefrom, which pallet layers can be stacked on top of one another in larger numbers and combined to form stacking pallets with filled cans.

However, it should be emphasized that the possible applications of the apparatus according to the invention are by no means limited to the handling and negative pressure-controlled gripping and positioning of empty cans, but that completely different articles, goods, packaging units, packs, etc. can be handled therewith, as has already been clarified above in brief form.

The apparatus according to the invention described here in various embodiment variants can be used in particular in conjunction with the delivery and provision of prepared empty cans and/or empty cans to be filled, but optionally also for handling other articles or products, wherein it may be necessary to grasp a larger number of empty cans by the gripping device of the apparatus both when delivering a larger number of empty cans on pallets and when preparing them for filling with liquid contents such as beverages in particular.

In general, the apparatus according to the invention can also be used in conjunction with the delivery and provision of primary packaging, containers, etc. that are prepared or to be filled, wherein it may be necessary to grasp a large number of primary packages or containers by the gripping device of the apparatus both when delivering a large number of such primary packages or containers on pallets and when preparing them for filling with liquid contents such as beverages in particular.

In general, the apparatus according to the invention can also be used in conjunction with the transfer, further transport and/or repositioning of processed primary packages, containers, etc. filled with liquid contents such as beverages, for example, wherein it may be necessary to grasp a large number of such primary packages or containers by the gripping device of the apparatus both when picking up or transferring a large number of such primary packages or containers from pallets or other provisioning stations and when they are further handled.

As can be seen from the above explanations, the apparatus according to the invention can be used in particular in the field of filling and packaging technology, i.e., in particular in the field of beverage processing or the processing of other liquid, pasty or granular products. Here, such gripping devices or suction plate grippers can be used advantageously for handling a large number of similar objects, articles, packages or containers.

The apparatus according to the invention comprises a movably suspended gripping device that is equipped with a suction surface on its lower side, to which the articles, containers, empty cans or the like grasped at their upper end faces can adhere if they are to be picked up from a base or from a provisioning station and transferred to a defined destination. The entire suction surface on the lower side of the gripping device can be subjected to negative pressure for this purpose, as a result of which the suction surface can grasp by suction a plurality of grouped articles, containers, empty cans or the like.

In particular, the gripping device can have a carrier plate that is provided on its upper side with a suspension, which can ensure its mobility within a defined movement space, in that the suspension can be connected to a movable portal suspension that sweeps over the movement space, to a movable arm of a multi-axis or articulated arm robot or the like. The movement space extends usefully, at least from a provisioning station, where a group of articles, containers, empty cans or the like is picked up, to a destination, where the picked-up articles, containers, empty cans etc. are set down again.

In order to be able to in each instance reliably grasp the articles, containers, empty cans or the like to be picked up, the suction surface located on the lower side of the carrier plate of the gripping device is covered with a layer that is elastically deformable and air-permeable, at least in certain regions, to which the articles, such as the empty cans, adhere as soon as the suction surface is subjected to sufficient negative pressure. This region of the suction surface can therefore also be regarded as the suction region or effective region of the suction plate gripper or apparatus according to the invention.

It makes sense that, in its dimensions, the layer that is air-permeable, at least in certain regions, is adapted to the carrier plate, so that its footprint is substantially repeated in the elastic layer anchored thereto. The footprint of the carrier plate can be square or rectangular, for example, but can also be adapted to the article grouping to be grasped in each instance, formed by an empty can grouping, for example.

In principle, the dimensioning of the carrier plate together with the layer that is air-permeable, at least in certain regions, arranged on the lower side depends on the respective practical handling requirements, i.e., in particular the requirements of the goods to be handled. The goods or articles to be grasped are normally formed in each instance by groups of closely spaced containers, such as empty cans, which are in contact with one another, particularly at their casing surfaces. Each grouping to be grasped can comprise, for example, more than twenty up to more than 200 empty cans or other articles.

Optionally, the articles to be grasped in a grouping can be arranged next to one another in a rectangular arrangement. However, pallet layers or groupings can also be grasped and picked up by the gripping device if the articles are not grouped in a regular rectangular arrangement, but for example in a denser spherical packing or in a hexagonal arrangement. In principle, the gripping device of the apparatus according to the invention would also be suitable for handling disordered accumulations of articles, provided that these are in each instance in an upright position in which their casing surfaces are aligned vertically, so that their open or closed upper sides face the suction surface of the gripping device and can thus all be contacted by the layer and sucked in by negative pressure.

According to a useful application variant of the present invention, the empty cans to be grasped in a grouping can be arranged next to one another in a rectangular arrangement. However, pallet layers or groupings can also be grasped and picked up by the gripping device if the empty cans are not grouped in a regular rectangular arrangement, but instead, for example, in a denser spherical packing or in a hexagonal arrangement. In principle, the gripping device of the apparatus according to the invention would also be suitable for handling disordered accumulations of empty cans, provided that these are in each instance in an upright position in which their casing surfaces are aligned vertically, so that their open upper sides face the suction surface and can thus all be contacted by the layer and sucked in by negative pressure.

In practice, the drying device assigned to the apparatus or that can be at least temporarily coupled to the apparatus can be configured in very different ways. The most important function of the drying device is its interaction with the layer attached to the suction surface, in order to at least partially remove moisture that is bound or adhering in this layer.

In order to pick up articles or containers such as empty cans, for example, the gripping device is lowered onto the grouping to be grasped, wherein the flexible layer can be pressed lightly onto the upper regions of the articles or containers, i.e., onto the upper edges of the cans, for example, so as not to allow the escape of too much of the negative pressure required to suck in the articles, containers, empty cans or the like. The articles, containers, empty cans or the like sucked into the layer in this way can be lifted from the provisioning station by moving the gripping device accordingly and transported in the desired direction to a defined destination.

The sucking in of the articles, containers, empty cans or the like of the grouping to be picked up is effected by activating a negative pressure source, which is able to establish the connections between the negative pressure source and the at least partially air-permeable layer via air-guiding lines as soon as the layer is positioned on the upper sides of the articles or containers to be picked up, i.e., e.g., the empty cans. In order to distribute the suction pressure generated by the negative pressure source over the entire suction surface on the lower side of the carrier plate, the air-guiding lines in the carrier plate preferably branch out in multiple ways, as a result of which an almost uniform distribution of the suction pressure over the entire surface of the air-guiding layer can be achieved.

Since the layer that is elastically deformable and is air-permeable, at least in certain regions, is in particular a foam layer with an open-pored structure, it is suitable on the one hand for serving as an air-guiding layer that distributes the suction pressure generated by the negative pressure source and evenly distributed via the lines and introduced into the layer largely homogeneously over the entire suction and contact surface on the lower side of the carrier plate. In addition, due to its elastic deformability, it is particularly suitable for reliably picking up a large number of grouped articles, containers, empty cans etc. without the risk of incorrect suction with all its risks, for example due to individual articles, containers, empty cans, etc. not being picked up or falling down.

In combination with the elastic properties of the layer, the air-permeable layer, which guides the air and distributes the suction air almost homogeneously throughout its volume, ensures the desired reliability in the negative pressure-induced pick-up, adhesion and separation of the grouped articles, containers, empty cans or the like from the suction surface at the desired destination by deactivating the negative pressure.

On the other hand, such open-pored foam layers, as formed by the air-guiding and air-permeable layer described here, generally tend to absorb and store moisture and condensation water. This general tendency to absorb moisture depends on the prevailing ambient conditions in each instance, but in the present application it is additionally promoted by the constantly repeated application of the suction pressure.

It is true that the articles, containers, empty cans and the like picked up do not normally contain any moisture, unless they have been sterilized and/or cleaned beforehand using cleaning fluid or hot water. Nevertheless, the normally prevailing ambient conditions with normal humidity are already sufficient that, after a certain period of use and multiple cycles of activating and deactivating the suction pressure provided by the negative pressure source, the moisture contained in the air sucked in increasingly accumulates in the air-guiding and air-permeable layer.

Practice has shown that such an accumulation of moisture in the layer consisting of the open-pored foam is not only suitable for reducing the suction pressure at least slightly, which can be easily compensated for by adjusting the power of the negative pressure source accordingly. Nevertheless, the water stored in the foam layer disturbs the air distribution, so that articles, containers, empty cans or the like are increasingly sucked in incorrectly and incompletely, which can lead to errors when lifting off the articles, containers, empty cans or the like to be picked up. Since open-pored foam structure is a structure with very fine ducts, the bound water cannot be neglected, since it has a noticeable negative effect on air distribution.

In addition, the accumulation of moisture in the layer arranged on the lower side of the suction surface or forming the suction surface, which forms a contact layer for the articles, containers, empty cans or the like that are grasped and handled therewith, represents a hygiene problem that becomes increasingly serious with longer operating times based on the associated potential formation of germs, so that in practical operation the layer anchored to the carrier plate has to be replaced frequently and repeatedly.

At the start of a handling cycle, the air-guiding and air-permeable layer has a very low moisture content, since it contains very little condensed liquid. However, after a long operating time and a large number of handling cycles being carried out, the air-guiding layer can have an increased moisture content that is no longer acceptable for further operation. In order to remove this undesired moisture, which consists mainly of absorbed condensation water, from the layer as far as possible or at least to significantly reduce the moisture content in the layer, the aforementioned drying device is used.

With a first embodiment variant of the apparatus according to the invention, the drying device does not require any additional components, but is substantially only realized by changing the operating mode of the apparatus. If the drying device is defined at this point as a blowing device that is coupled or can be coupled to the suction surface and with which the air-guiding elastic layer can be blown out and the moisture that is bound therein can be reduced, then the already existing negative pressure source is normally used as such a blowing device.

Here, a drying mode can be activated in particular by reversing the negative pressure source. In order to achieve this, a suction pump used as a negative pressure source does not necessarily have to be switched to an actual reverse mode, but it is sufficient to switch the line connections so that the suction side of the negative pressure source or suction pump can be supplied with ambient air or with dried air and the pressure side of the pump can be connected to the lines of the apparatus, so that the lines running through the carrier plate and in particular the air-guiding layer can be connected to the pressure side of the pump and in this way be blown out when the pump is activated.

The negative pressure source or suction pump, which operates in reverse mode in this way and thus functions as a drying device, acts as an air-conveying device coupled with the suction surface and the air-conveying layer for blowing out the layer and for reducing the moisture that is bound therein.

As a technical alternative to such a reversing operation of the negative pressure source, a separate blow-out device can also be connected to the lines of the gripping device as a drying device, which, instead of the deactivated negative pressure source, can ensure that the layer is blown out and at least some of the moisture that is bound therein is removed.

Optionally, it can also be provided that the blowing device, which acts as a drying device, i.e., possibly the negative pressure source operating in reverse mode or a separate pressure source, is supplied and operated with dried and/or heated or tempered blowing air, so that the dried and/or heated air conveyed thereby leads to faster drying of the layer and to an even more effective reduction of the moisture that is bound therein.

With the aforementioned operating variants of the drying device, an air dryer can also be used as an option, which can make the drying process even more effective when blowing out the layer with compressed air. This applies both to the aforementioned options of the negative pressure source operating in reverse mode and to the alternative option of a separate blow-out device as a drying device that can be connected to the lines. With both variants, the use of an additional air dryer can speed up the drying process when the layer is blown out, since the removal of at least some of the moisture that is bound therein is faster if the drying air blown in contains less moisture on its part.

This optional air dryer can also be combined with the above-mentioned heating device, so that the air blown into the layer can be additionally dried and/or heated as required.

Since the term “drying device that can be coupled to the apparatus or that forms a component of the apparatus” used here is to be understood comprehensively, it may also be useful in an alternative configuration of the apparatus to provide the drying device as an integrated component in the air-permeable layer.

For example, the drying device can comprise electric heating wires that run within the layer and can be structurally integrated therein. As required, these electric heating wires can be connected to a suitable electric power supply and heated in this way, which in turn can ensure the removal of the condensed moisture that is bound in the layer.

The condensed moisture removed from the layer in this way by powering the electric heating wires by the electric power supply can escape as liquid, but also as water vapor, wherein a stronger heating of the electric heating wires running within the layer will lead to increased escape of water vapor and to lower proportions of removed liquid. However, the degree of heating of the heating wires is limited by the thermal capacity of the air-permeable layer, which is normally made of foam.

In particular, the electric heating conductors can be guided in a meandering manner in a plurality of adjacent or parallel loops and possibly also in a plurality of layers stacked on top of one another within the layer, as a result of which an approximately uniform heating of the entire layer can be achieved and the formation of spots of localized heating and other spots that are heated to a lesser extent can be avoided. Such uneven heating would impair the desired effect and could lead to individual pockets of moisture remaining in the air-permeable layer.

Instead of electric heating wires, film portions can also be integrated in the air-permeable layer, which act as electric heating conductors and can be heated by connecting them to the electric power supply.

Optionally, the drying device of the apparatus according to the invention can also be formed by a heatable carrier plate, to the lower side of which the air-guiding and air-permeable layer is fastened, so that this layer can be heated via the heatable carrier plate.

The carrier plate is normally a structural component of the gripping device, since the air-guiding regions and the elastic layer providing the suction surface for the empty cans require a housing, a suspension and an anchoring. Thus, the heatable carrier plate in turn forms a structural component of the apparatus according to the invention, comprising the drying device.

The heatable carrier plate can, for example, be equipped with an integrated electric heater or with air ducts for the passage of hot air. In addition, liquid-guiding ducts are also conceivable which run through the carrier plate in order to heat it temporarily and, if applicable, permanently by tempered liquid.

Such an embodiment, with which the carrier plate of the gripping device can be heated temporarily or permanently, can also offer the advantage that the moisture that is bound in the layer is constantly removed, so that the loading of the layer with condensed moisture can be kept permanently low and thus generally at a significantly lower level.

A drying device that is not permanently coupled to the apparatus, which is separated from the apparatus during regular operation and is only coupled thereto as required, can optionally comprise a support plate or be formed by a support plate onto which the gripping device can be lowered in such a way that the air-permeable layer is pressed onto the support plate largely with its entire lower suction surface.

As soon as the air-guiding and air-permeable layer of the gripping device contains an undesirably high amount of moisture that is bound therein, it can be pressed evenly against the support plate from above by lowering the gripping device, which leads to compression of the air-guiding and air-permeable layer, as a result of which the water that is bound therein is pressed out of the layer on all sides.

Optionally, such a support plate can also be equipped with an integrated electric heater, which can be activated as required, in order to heat the air-permeable layer and remove as much of the moisture contained in the layer as possible when the gripping device is lowered onto the support plate.

Alternatively, the heatable support plate can also be equipped with air ducts for the passage of hot air. In addition, liquid-guiding ducts are also conceivable, which can run through the support plate, in order to heat it temporarily or permanently by tempered liquid.

With a further embodiment variant of the apparatus according to the invention for handling articles such as, for example, containers or empty cans, the drying device that can be coupled to the apparatus and/or interacts therewith can comprise at least one roller, in particular a cylindrical roller. On such a cylindrical roller, the carrier plate of the gripping device can be rolled in a horizontal direction and at a constant distance from the roller so that the layer is compressed and the condensation water that is bound therein is pressed out.

The preferably cylindrical roller is normally to be understood as a passive component, i.e., as a non-driven roller that is set in rotation by the rolling of the layer pressed against the roller and compressed at the same time. The roller preferably has a width that corresponds to at least one width of the carrier plate or the air-permeable layer arranged thereon.

Optionally, the gripping device can be moved through corresponding movements of the carrier plate, which is mounted on the suspension on its upper side, along with the air-guiding and air-permeable layer located on its lower side, in the direction of the stationary roller that is rotatably mounted about its longitudinal central axis. Alternatively, such a roller can also be moved in the direction of the carrier plate and the air-guiding and air-permeable layer arranged on its lower side and along the fixed carrier plate, in order to press the moisture out of the layer.

By rolling the elastic layer on the roller, which is set in rotation by this rolling, the layer is significantly compressed, while the carrier plate is moved relative to the roller. Depending on the degree of desired or achievable compression of the elastically compliant layer, the carrier plate can come very close to the roller. The closer the carrier plate comes to the roller during the rolling process and the stronger the elastic layer is compressed, the more water that is bound therein can be pressed out of the layer.

Optionally, the rotatable roller can also be profiled on its outer casing surface and, for example, be provided with webs, pins or the like, which can improve traction when rolling the layer on the roller and, under certain circumstances, also intensify the ejection process.

Optionally, the apparatus can be equipped with or coupled to a collecting device for collecting and, if applicable, discharging the water removed from the elastic and air-guiding layer. For example, a collecting basin can be provided below the gripping device, in which the liquid removed from the layer by the drying device, which operates in different ways, can be caught, collected and, if applicable, subsequently disposed of. However, since such a collecting device does not influence the effectiveness of the drying device, it should not be regarded as mandatory, but as optional.

A further embodiment variant of the apparatus according to the invention can be equipped with a drying device, which can be formed by an exchange station, in order to exchange the air-guiding and air-permeable layer, which is loaded with an excessively high moisture content, for a dry layer. If the drying device is to be formed by such an exchange station, it is useful if the layer can be easily detached from the lower side of the carrier plate, so that it can be removed in the exchange station and replaced with a dry layer of the same size. The layer detached from the carrier plate can be fed in each instance to a drying and/or cleaning process, for example.

If reference was previously made to a layer that is elastically deformable and air-permeable, at least in certain regions, this layer can optionally be an elastic layer or a foam layer with an only partially open-pore or closed-pore structure, which can be equipped with numerous suction and air guide openings. Thus, a larger number of such suction and air guide openings can optionally be provided in the layer, wherein typically the arrangement and the number of suction and air guide openings to be provided and present can correspond to the number of articles or empty cans to be picked up and their positions within the particular grouping.

With this embodiment variant, the air sucked in on the lower side of the suction surface can thus pass through the suction and air guide openings within the elastic layer consisting of foam or another elastic material and flow largely unhindered directly through the air-guiding lines and be sucked in by the negative pressure source, as soon as it is activated to pick up the articles or empty cans.

Here, the articles or empty cans sucked in are preferably only in contact with the foam or the lower side of the elastic layer, which can ensure the sealing off of respective suction and air guide openings from the environment. Due to the deformability of the layer formed from foam or other elastic materials, the desired sealing off can be ensured particularly well.

Thus, it should be clarified at this point that the air-guiding layer does not necessarily conduct the air sucked in through its structural set-up, as is the case with an open-pored foam structure without the optional suction and air guide openings, for example, but that, depending on the embodiment variant, only the suitably arranged and suitably formed suction and air guide openings can represent the air-guiding elements within the layer.

Depending on the selected variant of the apparatus according to the invention, the foam structure of the layer thus does not directly form the air-guiding layer, but primarily has the task of accommodating the suction and air guide openings and, in addition, the task of preventing or at least limiting the suction of false air, which could flow through gaps between the articles or empty cans and the suction surface, if and as soon as the articles or empty cans to be picked up are in contact with the layer.

Based on its elastic deformability and the large number of its suction and air guide openings, the layer structured in this way is also particularly well suited for reliably picking up a large number of grouped articles or empty cans, without the risk of incorrect suction with all its risks, for example due to individual articles or empty cans not being picked up or falling down.

Optionally, the structure, as described here using the example of an only partially open-pored or a closed-pored foam, can also be formed by an elastic layer with the aforementioned openings, the elasticity of which is not created by a foam structure, but by the elastic material properties. Thus, it should be clarified at this point that the layer can be formed by any elastic layer having the described suction and air guide openings.

In addition, such suction plate grippers, as described here using the gripping device, can optionally have valve controls. Here, the air-guiding layer can be assigned a larger number of valves, which can be formed by balls or freely movable valve bodies within the suction and air guide openings or within the air lines in the region of the contact or carrier plate located above. These balls or freely movable valve bodies can open the corresponding supply line to each of the suction and air guide openings as soon as the negative pressure generated by the negative pressure source is applied there.

Such a valve control system can offer the additional advantage that only those suction and air guide openings are activated where there is actually a product to be sucked in, i.e., an article, a container or, e.g., an empty can. If this is the case, the valve remains open due to the suction force exerted by the negative pressure. If, on the other hand, the particular suction and air guide opening is unoccupied because there is no product to be sucked in at this point, the valve can close and air is prevented from being sucked in there unnecessarily and the negative pressure system from conveying air unnecessarily.

The arrangement and respective number of suction and air guide openings that may be present and the optional valves depend on the size and number of objects to be sucked in. For larger packaging units that are to be picked up with the gripping device, the suction and air guide openings can also be adapted, arranged and, if applicable, made larger in diameter.

As a purely precautionary measure, it should be pointed out once again at this point that the apparatus according to the invention is also capable of picking up a wide variety of articles by the gripping device. Therefore, if empty cans are referred to at any point in this description, this term can in principle also be replaced by other terms, for example by the following terms: piece good, article, container, can, beverage can, flat packaging sheet or packaging blank, etc. Such a shift or modification of terms does not in any way affect or alter the statements regarding the nature of the present invention.

In addition, a humidity sensor can optionally be provided with all the above-mentioned embodiment variants of the apparatus according to the invention, which can be assigned to the air-guiding layer or installed therein. Optionally, a plurality of such humidity sensors can also be provided, which in each instance can be assigned to the air-guiding layer. The at least one humidity sensor can be coupled to a control device and supply its output signals to the control device, which in turn can control and activate the drying device in different ways, depending on the embodiment variant, i.e., as required.

The at least one humidity sensor optionally assigned in each instance to the layer in all described variants of the apparatus according to the invention, which, if present, is preferably coupled to the described control device or supplies its output signals to the control device, can also trigger other actions if this is desired or required in individual cases.

For example, on the basis of the output signals of a humidity sensor, on the one hand, the control device can control and activate the drying device in different ways as required, i.e., initiate the corresponding drying process. However, it is also conceivable if a fault message is derived from the output signals and output by the control device and/or transmitted to other units or machine modules coupled thereto. Such a fault message output, if applicable, by the control device can then, for example, serve as a reason for manual or machine-supported intervention by an operator or by service personnel.

In conjunction with the explanation of the preferably existing control device, it should be pointed out that such a control device can optionally be a sub-assembly of a machine control system, which preferably not only controls the regeneration processes of the apparatus according to the invention, but which can also generally control all its actions for picking up, handling and positioning articles such as containers, cans or empty cans. Since apparatuses such as those described here normally have such control devices, it should be clarified at this point that the apparatus according to the invention can be such an apparatus, which is controlled and operated via a suitable control device. However, this also means that the control device can be optionally assigned to the apparatus according to the invention or be a part of this apparatus.

This control device, which is optionally assigned to the apparatus according to the invention or which forms a component of the apparatus according to the invention, can in turn, according to a preferred embodiment variant, process the above-mentioned sensor signals, by which in particular the sensor signals of the above-mentioned humidity sensor can be meant, in order to control the regeneration cycles usefully and to carry them out at the suitable point in time in each instance.

It is clear from what has been said that the apparatus according to the invention can also be regarded as a regeneration system that can serve to restore favorable operating conditions of the gripping device by removing moisture from the air-guiding and air-permeable layer, which consists in particular of open-pored, elastically deformable foam, on the lower side of a plate-like gripper for picking up article groupings, container groupings, empty can groupings or empty can layers, and is thereby brought into an improved and preferably into an optimal operating state with regard to its gripping properties, its reliability when gripping the articles, containers, empty cans, etc., and with regard to its hygienic parameters. This regeneration of the air-guiding and air-permeable layer can be effected as required, which can be determined in particular by the loading of the layer with undesired condensation water.

In order to be able to determine when this loading of condensation water has reached an unacceptable level, the aforementioned sensor can be used, which is able to measure the humidity in the air-guiding layer. If sufficient experience is available for the operation of such a system, such a sensor evaluation can be dispensed with if applicable, and repeated regeneration cycles can be carried out at regular intervals or after a specified number of handling steps.

It should therefore be pointed out at this point that the apparatus equipped with the drying device or that can be coupled to the drying device at least temporarily and/or as required in accordance with one of the embodiment variants described above can in principle also be regarded as a regeneration system and designated as such. This also means that the reader could substitute the alternative term “regeneration system” for the term “apparatus” at any point where it is used, without affecting or altering the nature of the invention.

If, from the point of view of a person skilled in the art, a useful combination with one another is possible, some of the or all of these above-mentioned variations or embodiment variants of the method according to the invention and/or of the apparatus according to the invention can optionally also be combined with one another in order to at least partially achieve the above-formulated objective(s), and/or to achieve the desired effect of the invention.

For achieving at least part of the stated objectives, the invention further proposes, in addition to the apparatus according to the invention described in various embodiment variants, a method for regenerating a suction surface of a gripping device, which comprises a movably suspended plate-like suction cup, which can be subjected to negative pressure over its entire surface, in order to suck in and grasp a plurality of articles, containers, empty cans or the like on a lower side, in that they are sucked in to an air-permeable elastic layer when suction pressure is applied. The method can provide for drying processes carried out regularly or as needed, during which moisture is removed from the layer.

With the method according to the invention, the term “suction surface” used here is also intended to refer in particular to a suction region of the gripping device used in the method, which suction region comes into contact with the articles to be grasped and brought into adhesion to the suction surface by negative pressure. This suction region, substantially formed by the suction surface, can optionally also be regarded as the suction region, the contact surface or the effective region of the gripping device to which negative pressure can be applied and can be designated as such.

With the method, it can be provided, for example, that the moisture is pressed out of the elastic layer in that it is compressed.

The method serves to regenerate a moist elastic layer as required and can be carried out in particular in and with an apparatus according to any of the embodiment variants described above.

It is also clear from what has been said that the handling apparatus according to the invention and/or the method according to the invention can generally also be regarded as a regeneration method that serves to restore favorable operating conditions of the gripping device described by removing moisture from the air-guiding and air-permeable layer, which consists in particular of open-pored elastically deformable foam, on the lower side of a plate-like gripper for picking up article groupings, container groupings, empty can groupings or empty can layers, and is thereby brought into an improved and preferably into an optimal operating state with regard to its gripping properties, its reliability when gripping the articles, containers, empty cans, or the like, and with regard to its hygienic parameters. As already explained several times, the regeneration of the air-guiding and air-permeable layer can be effected as required and, for example, with the support of sensors, which can be determined in particular by the loading of the layer with undesired condensation water.

In order to be able to determine when this loading of condensation water has reached an unacceptable level, the aforementioned sensor can be used and its output signals can be processed to provide a statement about the moisture content in the air-guiding layer. However, if sufficient experience is available for the operation of such a system, such a sensor evaluation can be dispensed with if applicable, and repeated regeneration cycles can be carried out at regular intervals or after a specified number of handling steps.

Other actions can also be triggered on the basis of the signals provided by such a humidity sensor. For example, a fault signal can be generated which indicates to a person responsible for monitoring the apparatus that a regeneration cycle and/or replacement of a layer loaded with excessively high moisture may be necessary.

It should be expressly mentioned at this point that all aspects and embodiment variants that have been explained in conjunction with the apparatus (or the regeneration system) according to the invention can equally relate to or form aspects of the regeneration method according to the invention. Therefore, if at any point in the description or in the claim definitions for the apparatus according to the invention (or for the regeneration system according to the invention), reference is made to certain aspects and/or relationships and/or effects, this applies equally to the regeneration method according to the invention.

The same applies vice versa, so that all aspects and embodiment variants that have been explained in conjunction with the regeneration method according to the invention can also equally relate to, or be, partial aspects of the handling apparatus (or the regeneration system) according to the invention. Therefore, if at any point in the description or the claim definitions for the regeneration method according to the invention, reference is made to certain aspects and/or relationships and/or effects, this applies equally to the handling apparatus (or to the regeneration method) according to the invention.

### BRIEF DESCRIPTION OF THE FIGURES

Exemplary embodiments of the invention and their advantages are explained in more detail below with reference to the accompanying figures. The proportions of the individual elements relative to one another in the figures do not always correspond to the actual proportions, since some forms are simplified, while other forms are shown enlarged in relation to other elements for better illustration.

FIG. 1A shows a first embodiment variant of an apparatus for grasping empty cans, which is positioned on a grouping of articles, in each instance formed by empty cans.

FIG. 1B shows the apparatus according to FIG. 1A, which has grasped a grouping of empty cans and picked them up from a provisioning station.

FIGS. 2A to 2C show various operating phases of a first embodiment variant of an apparatus according to the invention, which is equipped with a drying device.

FIG. 3A shows a further embodiment variant of the apparatus according to the invention, which is equipped with a drying device within an air-guiding layer.

FIG. 3B shows a further embodiment variant of the apparatus according to the invention, which is equipped with a drying device within a carrier plate, on which carrier plate the air-guiding layer is arranged.

FIGS. 4A and 4B show a further embodiment variant of the apparatus according to the invention, which is equipped with a drying device in the form of a support plate interacting with the apparatus.

FIGS. 4C and 4D show a further equipment variant of the embodiment variant according to FIGS. 4A and 4B, with which the support plate can be heated.

FIGS. 5A to 5C show a further embodiment variant of the support plate according to the invention, with which the drying device is formed by a roller interacting with the apparatus.

FIGS. 6A to 6D show a further embodiment variant of the apparatus according to the invention, with which the drying device is formed by an exchange station.

FIGS. 7A and 7B show, in two schematic sectional views, a possible configuration of an air-guiding layer of a gripping device equipped with numerous suction and air guide openings, which is part of the apparatus according to the invention.

### DETAILED DESCRIPTION OF THE INVENTION

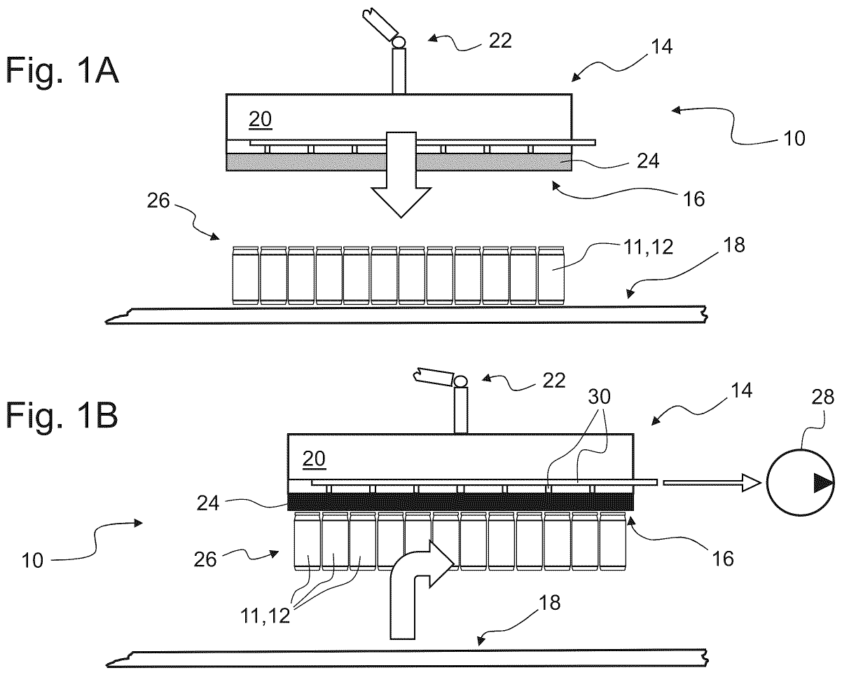

As a rule, the same reference numerals in each instance are used in FIG. 1A to 7B for elements of the invention that are identical or have the same effect. Furthermore, in many cases for the sake of clarity, in the individual figures only reference numerals that are necessary or useful for the description of the figure in question are shown. The illustrated embodiments are merely examples of how the invention can be configured, and are non-limiting. The features described below in each instance are also not to be understood in close connection with further features of the particular exemplary embodiment, but can be provided in each instance in a general context or used for this purpose.

FIGS. 1A and 1B in each instance show schematic side views of an embodiment variant of an apparatus 10 according to the invention, which serves to handle articles 11 in the form of empty cans 12. In the present context, the term “empty cans” 12 refers in particular to metal beverage containers or beverage containers made of sheet metal in the form of cans with openings on their upper side, which generally have a hollow cylindrical shape with a flat top lid on its end face and a bottom surface that, on its end face, is flat or concavely curved in portions. In the state not yet filled with liquid contents such as a beverage, for example, the upper lid can still be partially or completely missing, so that the empty cans 12 are substantially characterized by a hollow cylindrical shape with a closed bottom side and an open upper side, which hollow cylindrical shape can be produced in particular by a deep-drawing process for the plastic forming of sheet metal portions.

Therefore, if reference is made in the present context to empty cans 12 with openings on their upper side, this normally refers to a raw state of the empty cans 12 that are to be grouped, repositioned, unstacked, depalletized, stacked again-possibly in a different grouping—or otherwise handled in larger numbers prior to their respective filling with liquid contents and prior to their respective airtight sealing by placing a lid on their upper side (not shown here). The lids that are placed on the cans after filling—now no longer to be referred to as empty cans 12—are generally positioned on top and can be applied to the upper end faces of the respective cans, in particular by a sealing press joint and/or flared joint, after which the cans filled and sealed in this way can be subjected to further treatment and/or handling steps.

Such further treatment steps can comprise, for example, printing on the casing side or attaching printed labels. Further handling steps refer in particular to grouping, bundling and packaging processes, since a plurality of cans are often combined to form packs before large packs or pallet layers are formed therefrom, which pallet layers can be stacked on top of one another in larger numbers and combined to form stacking pallets with filled cans.

However, it should be emphasized again at this point, as already mentioned above, that the apparatus 10 according to the invention is not only suitable for handling empty cans 12, but that the articles 11 gripped and picked up by negative pressure and set down at a destination can also be formed by other goods, such as filled cans, bottles, containers, packaging units, packs or the like. The articles 11, which are picked up by the apparatus 10 using negative pressure, can optionally also be formed by flat objects such as packaging means, intermediate layers for use between layers of pallets stacked on top of one another, etc.

Therefore, if the apparatus 10 and its mode of operation are illustrated in the present exemplary embodiment using a handling of empty cans 12, a person skilled in the art as reader should understand this as an application example for the handling of articles 11, wherein these articles 11 can be a wide variety of goods, which can optionally be handled in a larger number in grouped form. However, this should also not be understood to be restrictive, because the apparatus 10 is also capable in principle of picking up individual goods or articles 11 or a few ordered or unordered articles 11 at the same time.

The apparatus 10 shown in FIGS. 1A to 7B by way of example and in each instance in schematic side views can be used in particular in conjunction with the delivery and provision of empty cans 12 that are prepared or are to be filled, wherein the grasping of a larger number of empty cans 12 by such an apparatus 10 may be necessary both when delivering a larger number of empty cans 12 on pallets and when preparing them for filling with liquid contents, in particular beverages.

As has already been clarified above, the apparatus 10 according to the invention can be used in particular in the field of filling and packaging technology, i.e., in particular in the field of beverage processing or the processing of other liquid, pasty or granular products. Here, such gripping devices 14 or suction plate grippers, as will be described below, can be advantageously used in particular for handling a larger number of similar objects, articles, packages or containers.

The apparatus 10 shown comprises a movably suspended gripping device 14 that is equipped with a suction surface 16 on its lower side, to which the articles 11 or empty cans 12 grasped on their upper side can adhere if they are to be picked up from a base or from a provisioning station 18 and transferred to a destination—not shown or designated in more detail here. The entire suction surface 16 located on the lower side of the gripping device 14 can be subjected to negative pressure for this purpose, as a result of which the suction surface 16 is capable of grasping by suction a plurality of grouped empty cans 12.

As illustrated schematically in FIG. 1A, the gripping device 14 can in particular have a carrier plate 20 that is provided on its upper side with a suspension 22, which can ensure its mobility within a movement space not designated here, in that the suspension 22 can be connected, for example, to a movable portal suspension that sweeps over the movement space, to a movable arm of a multi-axis or articulated arm robot or the like. The movement space usefully extends at least from the provisioning station 18, from which a group of articles 11 or empty cans 12 is picked up, to a destination, where the picked-up articles 11 or empty cans 12 are set down again.

In order to be able to reliably grasp the articles 11 or empty cans 12, the suction surface 16 located on the lower side of the carrier plate 20 of the gripping device 14 is covered with a layer 24 that is elastically deformable and air-permeable, at least in certain regions, to which the articles 11 or empty cans 12 adhere as soon as the suction surface 16 is subjected to sufficient negative pressure. It makes sense that, in its dimensions, the layer 24 that is air-permeable, at least in certain regions, is adapted to the carrier plate 20, so that its square or rectangular footprint in particular is also substantially repeated in the layer 24 anchored thereto.

The dimensioning of the carrier plate 20 together with the layer 24, which is air-permeable, at least in certain regions, and is arranged on the lower side, depends on the respective requirements. Thus, the schematic side views of FIGS. 1A and 1B indicate an exemplary grouping 26 of closely spaced empty cans 12, which are in contact with one another in particular at their casing surfaces, with the visible longitudinal side of the grouping 26 comprising twelve empty cans 12. If the grouping 26 is a square arrangement or pallet layer of similar empty cans 12, it comprises a total of one hundred and forty-four empty cans 12.

However, these figures are to be understood as merely exemplary, since the grouping 26 to be handled by the gripping device 14 of the apparatus 10 can also comprise fewer or more than the aforementioned one hundred and forty-four empty cans 12. In addition, the gripping device 14 of the apparatus 10 can optionally also handle groupings 26 of articles 11 other than the empty cans 12 shown, optionally in other sizes of the grasped groupings 26 than shown.

In addition, since pallet layers or groupings 26 can also be easily grasped and picked up by the gripping device 14, with which the articles 11 or empty cans 12 are not grouped in a regular rectangular arrangement, but rather, for example, in a denser spherical packing or in a hexagonal arrangement, the exemplary embodiment shown is not to be understood as limiting in this respect, but is substantially intended to illustrate the principles of the interaction of the gripping device 14, its layer 24 covering the suction surface 16 along with the articles 11 or empty cans 12 held thereon by negative pressure.

In principle, the gripping device 14 of the apparatus 10 would also be suitable for handling disordered accumulations of other articles 11 or empty cans 12, provided that these are in each instance in the position shown, in which their casing surfaces are aligned vertically, so that their open upper sides face the suction surface 16 and can thus all be contacted by the layer 24 and sucked in by negative pressure.

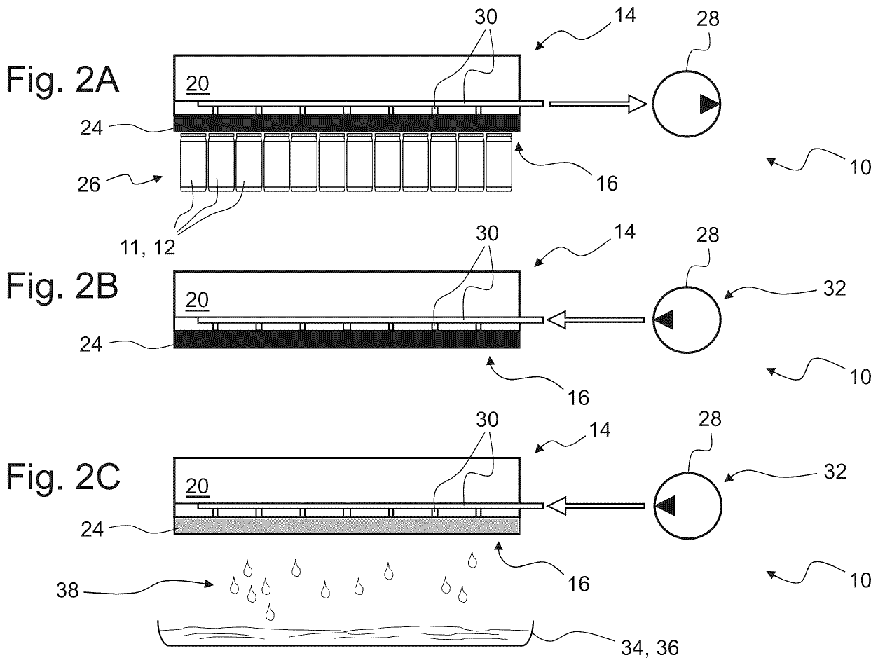

FIGS. 2A to 7B, explained below, also show various embodiment variants of a drying device 32, which can be an equipment component of the apparatus 10 or which can be coupled to the apparatus 10 at least temporarily. The most important function of the drying device 32 is its interaction with the layer 24 attached to the suction surface 16, in order to at least partially remove moisture that is bound or adhering in this layer 24.

While FIG. 1A shows the gripping device 14 located vertically above the grouping 26 with the empty cans 12 (or other articles 11) with the suction surface 16 spaced from the open upper sides of the empty cans 12, which gripping device is lowered onto the grouping 26 standing on the provisioning station 18 by corresponding movement of the suspension 22 in the direction of the arrow, FIG. 1B illustrates the empty cans 12 sucked in at the layer 24, which can be lifted from the provisioning station 18 by corresponding movement of the gripping device 14 and moved in the direction of the arrow to a destination not shown here.

The sucking in of the empty cans 12 of the picked-up grouping 26 is effected by activating a negative pressure source 28, which is only schematically indicated in FIG. 1B and which is able to establish connections between the negative pressure source 28 and the at least partially air-permeable layer 24 via air-guiding lines 30, as soon as the layer 24 is positioned on the upper sides of the empty cans 12. In order to distribute the suction pressure generated by the negative pressure source 28 over the entire suction surface 16 on the lower side of the carrier plate 20, the air-guiding lines 30 in the carrier plate 20 preferably branch out many times, as a result of which a uniform distribution of the suction pressure over the entire surface into the air-guiding layer 24 can be achieved.

The negative pressure source 28 can usefully be formed by a suction pump not explained in detail here or by a suction connection of a more complex supply system.

Since the layer 24 that is elastically deformable and is air-permeable layer, at least in certain regions, can, for example, be a foam layer with an open-pored structure, it is suitable on the one hand for serving as an air-guiding layer 24 that can distribute the suction pressure generated by the negative pressure source 28 and evenly distributed via the lines 30 and introduced into the layer 24 largely homogeneously over the entire suction and contact surface 16 on the lower side of the carrier plate 20. In addition, due to its elastic deformability, the layer 24 specified in this way is particularly suitable for reliably picking up a large number of grouped empty cans 12 without the risk of incorrect suction with all its risks, for example due to individual articles 11 or empty cans 12 not being picked up or falling down.

In combination with the elastic properties of the layer 24, the air-permeable layer 24, which guides the air and distributes the suction air almost homogeneously throughout its volume depending on the embodiment variant, ensures the desired reliability in the negative pressure-induced pick-up, adhesion and separation of the grouped empty cans 12 from the suction surface 16 at the desired destination by deactivating the negative pressure.

However, such open-pored foam layers, as can optionally be formed by the air-guiding and air-permeable layer 24 shown here, generally tend to absorb and store moisture and condensation water. This general tendency to absorb moisture depends on the prevailing ambient conditions in each instance, but in the present application it is additionally promoted by the constantly repeated application of the suction pressure.

It is true that empty cans 12 or other articles 11 picked up do not normally contain any moisture, unless they have been sterilized and/or cleaned beforehand using cleaning fluid or hot water. Nevertheless, the normally prevailing ambient conditions with their normal humidity values are already sufficient such that, after a certain period of use and multiple or repeated cycles of activating and deactivating the suction pressure supplied by the negative pressure source 28, the moisture contained in the air sucked in increasingly accumulates in the air-guiding and air-permeable layer 24.

Practice has shown that such an accumulation of moisture in the layer 24 consisting of the open-pored or closed-pored foam is not only suitable for reducing the suction pressure at least slightly, which can be easily compensated for by adjusting the power of the negative pressure source 28 accordingly. However, practice has also shown that the reliability of the suction is gradually reduced by increasingly impermeable fine pores in the foam, as a result of which not all empty cans experience the same holding force as is the case under optimal conditions and with a dry layer.

In addition, any accumulation of moisture in the layer 24 arranged on the lower side of the suction surface 16 or forming the suction surface 16, which forms a contact layer for the empty cans that are grasped and handled therewith, represents a hygiene problem that becomes increasingly serious with longer operating times based on the associated potential formation of germs, so that in practical operation the layer 24 anchored to the carrier plate 20 has to be replaced frequently and repeatedly.

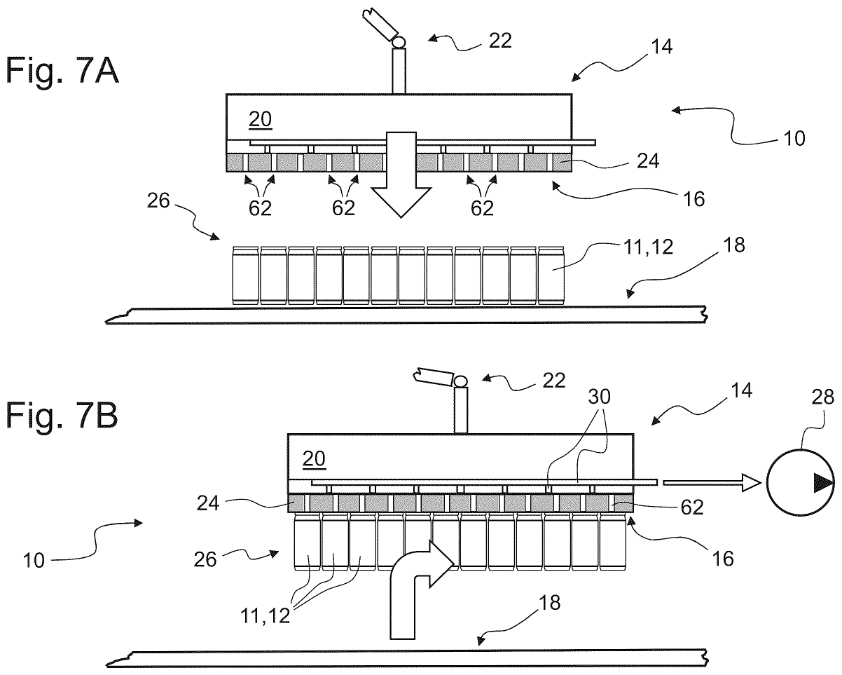

In principle, the layer 24 can also be configured in the manner shown in the sectional views of FIGS. 7A and 7B. For example, the layer 24 that is elastically deformable and air-permeable, at least in certain regions, can also be a foam layer with an only partially open-pored or closed-pored structure, which has suction and air guide openings, as shown in each instance in FIGS. 7A and 7B, while the foam structure substantially ensures that the suction and air guide openings arranged in the layer 24 are sealed off from the environment, if and as soon as the articles 11 or empty cans 12 to be picked up are in contact with the layer 24. Thus, due to its elastic deformability and the large number of its suction and air guide openings, the layer 24 formed in this way is also particularly well suited for reliably picking up a large number of grouped articles 11 or empty cans 12, without the risk of incorrect suction with all its risks, for example due to individual articles 11 or empty cans 12 not being picked up or falling down.

Such only partially open-pored or closed-pored foam layers can equally also have a tendency to absorb and store moisture and condensation water. This is because the normally prevailing ambient conditions with their normal humidity values cause an accumulation of moisture in the air-guiding and air-permeable layer 24 after a certain period of use and multiple or repeated cycles of activating and deactivating the suction pressure supplied by the negative pressure source 28 based on the moisture contained in the air sucked in.

Thus, the same potential hygiene risks arise here, which can be associated in particular with the formation of germs, so that in practical operation the layer 24 anchored to the carrier plate 20 must be replaced frequently and repeatedly.

In order to illustrate in FIGS. 1A to 7B that the air-guiding and air-permeable layer 24 initially has a very low moisture content and that it contains only a little condensed liquid, the layer 24 is partially shown in different shades (but not in FIG. 7B). Thus, the light shade of the layer 24 in FIG. 1A illustrates a still low moisture content, since here the apparatus 10 may be in an operating state in which only a few handling cycles have been carried out. In contrast, the dark shade of the layer 24 in FIG. 1B illustrates an increased moisture content that is no longer acceptable for further operation, since here the apparatus 10 may be in an operating state after carrying out a larger number of handling cycles.

In order to be able to remove this undesirable moisture, which consists mainly of absorbed condensation water, from the layer 24 as far as possible or to at least significantly reduce the moisture content in the layer 24, the apparatus 10 according to the invention is equipped with a drying device 32 or can be coupled at least temporarily to such a drying device 32, which drying device 32 can interact with the air-permeable layer 24 attached to the carrier plate 20 and forming the suction surface 16 in such a way, in order to at least partially remove the moisture that is bound or adhering therein and reduce it to a level acceptable for the further operation of the apparatus 10.

With a first embodiment variant of the apparatus 10 according to the invention, which is illustrated in the schematic side views of FIGS. 2A to 2C, a drying mode can be activated, for example, by a reversing operation of the negative pressure source 28 (see FIG. 2C). While FIG. 2A illustrates the normal operation of the air-permeable layer 24 connected to the air-guiding lines 30 with negative pressure for the sucking in of the grouping 26 with empty cans 12 held on the layer, with which the air-guiding layer 24 is loaded with an increased moisture content after a certain operating time (dark-shaded layer 24 in FIG. 2A), FIG. 2B illustrates an operation of the negative pressure source 28 with reversed flow direction, so that it can function here as a drying device 32.

The negative pressure source 28, which operates in reverse mode according to FIG. 2B and thus functions as a drying device 32, thus acts in this way as an air-conveying device coupled to the suction surface 16 and the layer 24 for blowing out the layer 24 and for reducing the moisture that is bound therein. In order to achieve this, it may be useful to reverse the conveying direction of the negative pressure source 28, which is required to generate the suction pressure, in order to apply a positive pressure to the suction surface 16 instead of a negative pressure and to pass it through the open-pored layer 24, which leads to the blowing out of the open-pored layer 24 and to the gradual removal of the moisture that is bound therein. This desired state is illustrated in FIG. 2C by the lighter shaded air-permeable layer 24, which is intended to illustrate the reduced moisture content in the layer 24.

As a technical alternative to such a reversing operation of the negative pressure source 28, a separate blow-out device can also be connected to the lines 30 as a drying device 32, which, instead of the deactivated negative pressure source 28, can ensure that the layer 24 is blown out and at least some of the moisture that is bound therein is removed.

If reference is made here to a negative pressure source 28, this can optionally be a negative pressure pump or also, e.g., a suction connection of an air pressure or negative pressure supply system, so that the drying device 32 can be realized by a differently connected suction pump, which can operate in pressure mode, or by a positive pressure connection of the air pressure supply system.

Optionally, it can also be provided that the blowing device, which acts as a drying device 32, i.e., possibly the negative pressure source 28 operating in reverse mode, is supplied and operated with heated or tempered blown air, so that the heated air generated thereby leads to faster drying of the layer 24 and to an even more effective reduction of the moisture that is bound therein.

In addition, the apparatus 10 can optionally be equipped with or coupled to a collecting device 34 for collecting and, if applicable, discharging the water removed from the layer 24. FIG. 2C illustrates such an option in the form of a collecting basin 36 arranged below the gripping device 14, in which the liquid 38 conveyed out of the layer 24 by the drying device 32 operating as a blow-out device can be caught, collected and, if applicable, subsequently disposed of.

Since such a collecting device 34, as shown schematically in FIG. 2C, does not influence the effectiveness of the drying device 32, it should not in principle be regarded as obligatory, but as optional.

With the operating variant of the drying device 32 shown in FIGS. 2A to 2C, an additional air dryer not shown here can optionally be used, which can make the drying process even more effective when blowing out the layer 24 with compressed air. This applies both to the aforementioned options of the negative pressure source 28 operating in reverse mode and to the alternative option of a separate blow-out device as a drying device 32 that can be connected to the lines 30. With both variants, the use of an additional air dryer can speed up the drying process when the layer 24 is blown out, since the removal of at least some of the moisture that is bound therein is faster if the drying air blown in contains less moisture on its part.

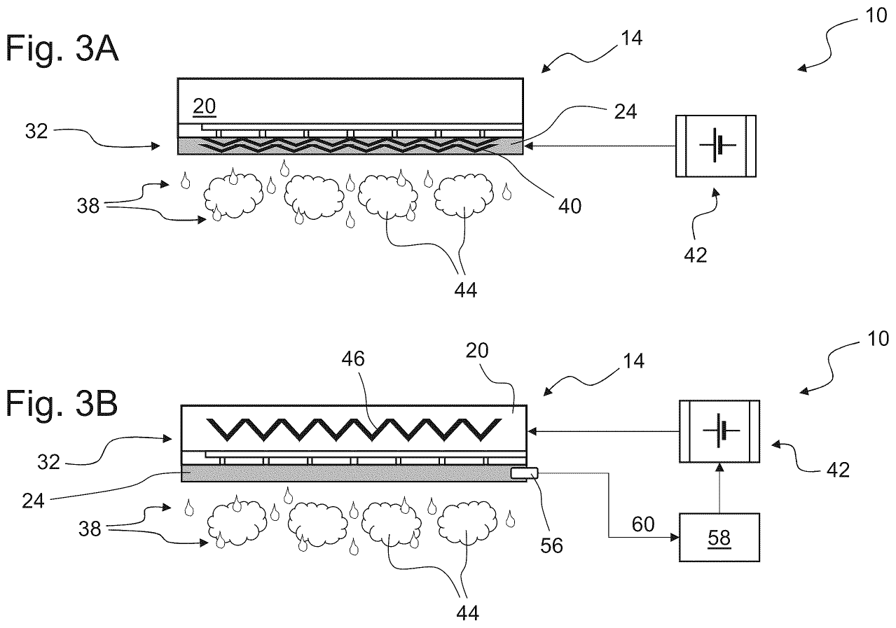

According to FIG. 3A, in an alternative configuration of the apparatus, it may also be useful to provide the drying device 32 as an integrated component in the air-permeable layer 24. For example, the drying device 32 can comprise electric heating wires 40 that run within the layer 24 and are structurally integrated therein. As required, these electric heating wires 40 can be connected to an electric power supply 42, which is only schematically indicated here, and heated in this way, which in turn can ensure the removal of the condensed moisture that is bound in the layer 24.

The condensed moisture removed from the layer 24 in this way by powering the electric heating wires 40 by the electric power supply 42 can escape as liquid 38, but also as water vapor 44, wherein a stronger heating of the electric heating wires 40 running within the layer 24 likely leads to increased escape of water vapor 44 and to lower proportions of removed liquid 38. However, excessive heating of the heating wires 40 is to be avoided in view of the risk of damage to the air-permeable layer 24, which is normally formed from foam.

The electric heating conductors 40 can be guided in a meandering manner in a plurality of loops and possibly also in a plurality of layers stacked on top of one another within the layer 24, as a result of which an approximately uniform heating of the entire layer 24 can be achieved and the formation of spots of localized heating and other spots that are heated to a lesser extent can be avoided. Such uneven heating would impair the desired effect and could lead to individual pockets of moisture remaining in the air-permeable layer 24.

Instead of electric heating wires 40, film portions can also be integrated in the air-permeable layer 24, which act as electric heating conductors and can be heated by connecting them to the electric power supply 42. A total area of the single-layer or multi-layer film portions located within the layer 24 should not impair the air permeability of the layer 24, so that a proportional total area of the film portions of no more than a maximum of 20% in relation to the footprint of the layer 24 should prove to be useful.

Optionally, the drying device 32 of the apparatus 10 according to the invention in accordance with FIG. 3B can also be formed by a heatable carrier plate 20, to the lower side of which the air-guiding and air-permeable layer 24 is fastened, so that this layer 24 can be heated via the heatable carrier plate 20.

This heatable carrier plate 20 can, for example, be equipped with an integrated electric heater 46 or with air ducts for the passage of hot air. In addition, liquid-guiding ducts are also conceivable, which run through the carrier plate 20, in order to heat it temporarily or permanently by tempered liquid.

However, FIG. 3B only graphically shows the variant with the electric heater 46 integrated in the carrier plate 20, which can be connected to an electric power supply 42 as required.

Such an embodiment, with which the carrier plate 20 of the gripping device 14 can be heated temporarily or permanently, can also offer the advantage that the moisture that is bound in the layer 24 is constantly removed, so that the loading of the layer 24 with condensed moisture can be kept permanently low and thus generally at a significantly lower level.

In turn, the condensed moisture thus removed from the layer 24 can escape both as liquid 38, but also as water vapor 44, wherein a stronger heating of the carrier plate 20 by the electric heater 46 integrated therein or by a heating fluid flow (not shown) will lead to increased escape of water vapor 44 and to lower proportions of removed liquid 38. In turn, excessive heating of the carrier plate 20 is to be avoided in view of the risk of damage to the air-permeable layer 24, which is normally formed from foam.

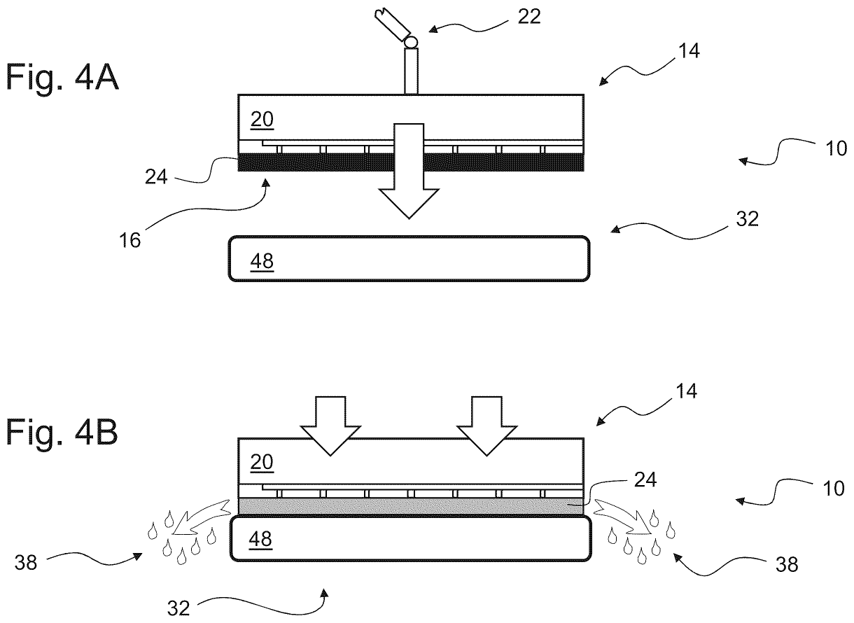

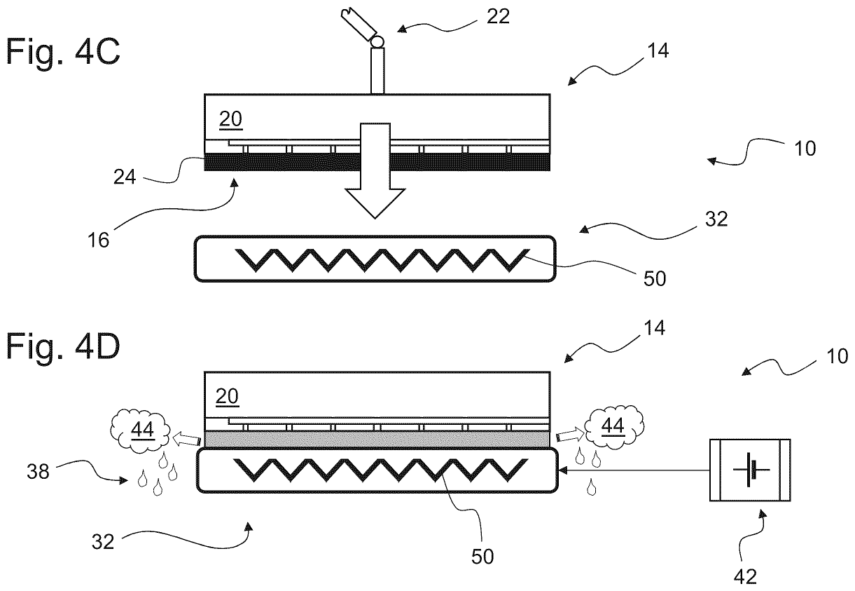

According to a further embodiment variant (see FIGS. 4A to 4D) of the apparatus 10 according to the invention, the drying device 32 can optionally also comprise a support plate 48 or be formed by a support plate 48, onto which the gripping device 14 can be lowered in such a way that the air-permeable layer 24 is pressed with its entire lower suction surface 16 onto the support plate 48.

The schematic side view of FIG. 4A illustrates the process of lowering the gripping device 14 in the direction of the arrow to the support plate 48. Here, the air-guiding and air-permeable layer 24 of the gripping device 14 contains an undesirably high amount of moisture that is bound therein, which is indicated by the darker shade of the layer 24 by the graphic representation.

The schematic side view of FIG. 4B illustrates the gripping device 14 pressed uniformly against the support plate 48 from above, which leads to compression of the air-guiding and air-permeable layer 24, as a result of which the water 38 that is bound therein is pressed out of the layer 24 on all sides. The moisture content reduced in this way within the layer 24 is illustrated graphically by the lighter shade of the air-permeable layer 24.

Optionally, the support plate 48 according to FIGS. 4C and 4D can additionally be equipped with an integrated electric heater 50, which can be activated as required, in order to heat the air-permeable layer 24 and to remove as much of the moisture contained in the layer 24 as possible when the gripping device 14 is lowered onto the support plate 48.

Optionally, the heatable support plate 48 can be equipped with the aforementioned integrated electric heater 50 or also with air ducts for the passage of hot air (not shown here). In addition, liquid-guiding ducts are also conceivable, which can run through the support plate 48, in order to heat it temporarily or permanently by tempered liquid. In FIGS. 4C and 4D, however, only the variant with the electric heating 50 integrated in the support plate 48 is shown graphically, which can be connected to an electric power supply 42 as required as soon as the gripping device 14 is lowered onto the support plate 48 with the suction surface 16 of the layer 24 in contact with the upper side of the support plate 48 over the entire surface (see FIG. 4D).

In turn, the condensed moisture removed from the layer 24 in this way can escape both as liquid 38, but also as water vapor 44, wherein a stronger heating of the support plate 48 by the electric heater 50 integrated therein or by a heating fluid flow (not shown) will lead to increased escape of water vapor 44 and to lower proportions of removed liquid 38. In turn, excessive heating of the support plate 48 is to be avoided in view of the risk of damage to the air-permeable layer 24, which is normally formed from foam.

The schematic side view of FIG. 4C illustrates the process of lowering the gripping device 14 in the direction of the arrow to the support plate 48. Here, the air-guiding and air-permeable layer 24 of the gripping device 14 contains an undesirably high amount of moisture that is bound therein, which is indicated by the darker shade of the layer 24 by the graphic representation.

The schematic side view of FIG. 4D illustrates the gripping device 14 pressed onto the support plate 48 heated by the electric heating device 50 integrated therein, which also leads to the desired heating of the air-guiding and air-permeable layer 24, as a result of which the moisture that is bound therein will escape from the layer 24 on all sides as water 38 as well as water vapor 44. The moisture content reduced in this way within the layer 24 is illustrated graphically by the lighter shade of the air-permeable layer 24.

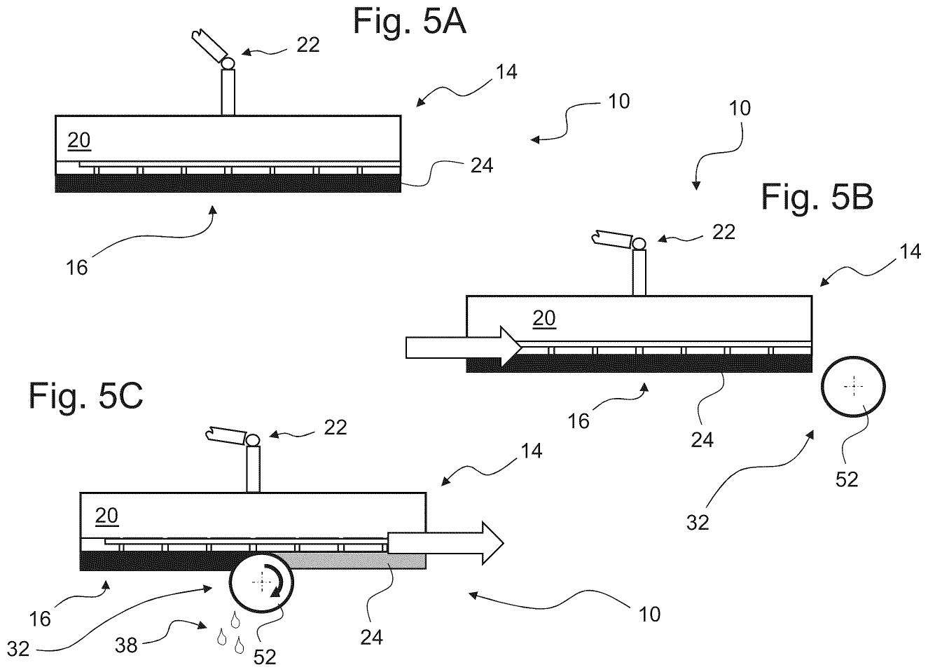

The schematic side views of FIGS. 5A to 5C show a further embodiment variant of the apparatus 10 according to the invention for handling empty cans 12 with a drying device 32 of a further different configuration. Thus, the drying device 32 here comprises at least one, in particular cylindrical, roller 52 or is substantially formed by an arrangement with such a cylindrical roller 52, on which the carrier plate 20 of the gripping device 14 can be unrolled in a manner in a horizontal direction and at a constant distance from the roller 52, in order to press out the condensation water contained therein by compressing the layer 24 in this way.

The preferably cylindrical roller 52 is normally to be understood as a passive component, i.e., as a non-driven roller 52 that is set in rotation by the rolling of the layer 24 pressed against the roller 52 and compressed at the same time. The roller 52 preferably has a width that corresponds to at least one width of the carrier plate 20 or the air-permeable layer 24 arranged thereon. A useful diameter of the rotatable roller 52 can correspond to at least three times the typical thickness of the elastically deformable and compressible layer 24 in its uncompressed state. Thus, if the elastically deformable and compressible layer 24 has a thickness of approximately two centimeters, the outer diameter of the preferably cylindrical roller 52 should be approximately six centimeters or more.

The schematic side view of FIG. 5A illustrates the gripping device 14, comprising the carrier plate 20 and the air-guiding and air-permeable layer 24 arranged on the lower side thereof, which layer in the exemplary embodiment shown is loaded with an undesirable amount of condensation water that is bound in the foam structure, which is shown graphically by the dark shade of the layer 24.

According to FIG. 5B, in such a case the gripping device 14 can be moved through corresponding movement of the carrier plate 20, which is mounted on the suspension 22 on its upper side along with the air-guiding and air-permeable layer 24 located on its lower side, in the direction of the stationary roller 52 that is mounted rotatably about its longitudinal central axis, i.e., in the direction of the arrow to the right in the graphic representation of FIG. 5B.

By rolling the elastic layer 24 on the roller 52, which is set in rotation by this rolling, the layer 24 is significantly compressed, while the carrier plate 20 is moved over the roller 52 according to FIG. 5C. Depending on the degree of desired or achievable compression of the elastically compliant layer 24, the carrier plate 20 can come very close to the roller 52. The closer the carrier plate 20 comes to the roller 52 during the rolling process and the stronger the elastic layer 24 is compressed, the more water 38 that is bound therein can be pressed out of the layer 24.

The schematic view of FIG. 5C illustrates the drying process during the horizontal displacement of the carrier plate 20 in the direction of the arrow to the right, in that the regions of the layer 24 that have already passed the rotating roller 52 and are therefore already to the right of the roller 52 are lighter in tone, which is intended to illustrate the lower water content of these regions. In contrast, the regions of the layer 24 that have not yet passed the rotating roller 52 and are therefore still to the left of roller 52 are darker in tone, which is intended to illustrate the higher water content of these regions.

Optionally, the rotatable roller 52 can also be profiled on its outer casing surface and, for example, be provided with webs, pins or the like, which can improve traction when rolling the layer 24 on the roller 52 and, under certain circumstances, also intensify the ejection process.

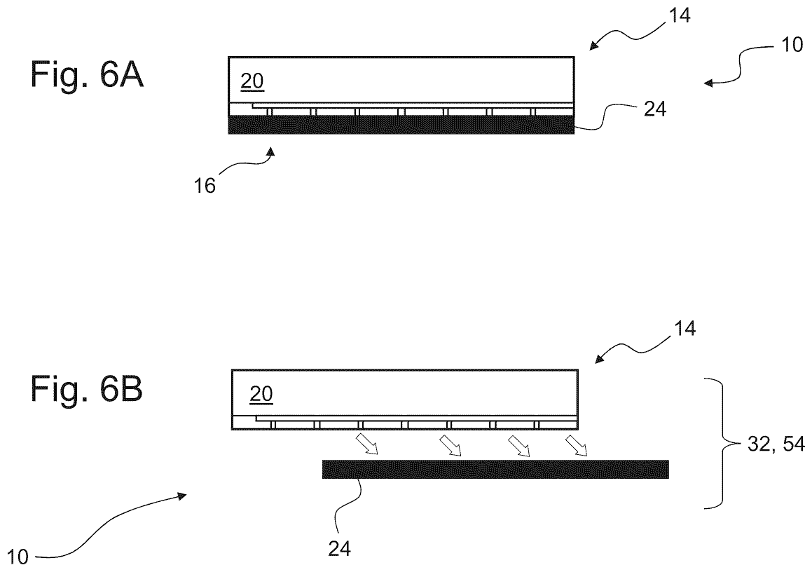

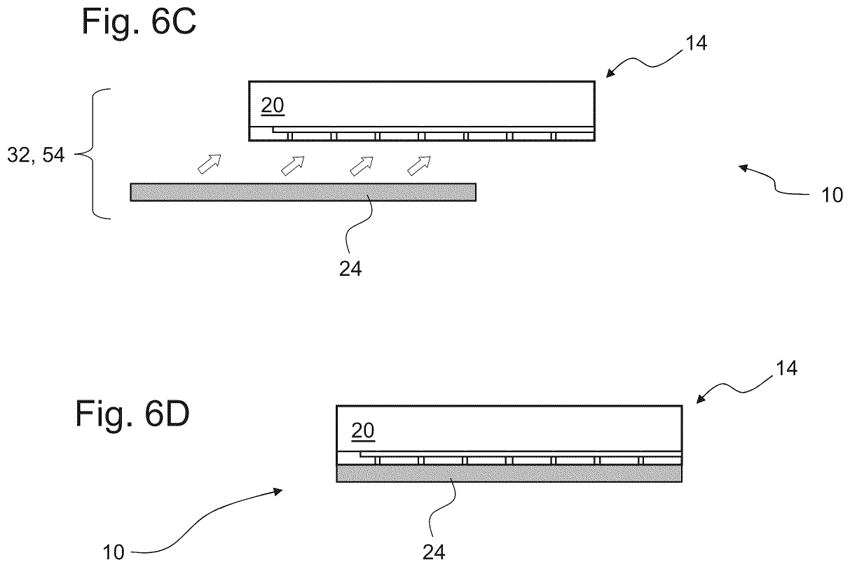

Finally, FIGS. 6A to 6D illustrate a further embodiment variant of the apparatus 10 according to the invention, with which the drying device 32 can be formed by an exchange station 54, which is merely indicated here, in order to exchange the air-guiding and air-permeable layer 24, which is loaded with an excessively high moisture content, for a dry layer 24.

In this case, the layer 24 must be easily detachable from the lower side of the carrier plate 20 so that it can be removed at the exchange station 54 and replaced with a dry layer 24 of the same size as soon as the exchange station 54 is approached in the rotation.

Thus, the schematic view of FIG. 6A shows a layer 24 loaded with moisture, which is shown graphically by its dark shade. According to FIG. 6B, the layer 24 loaded with moisture can be detached from the carrier plate 20 in the exchange station 54 and, for example, fed to a drying and/or cleaning process.

According to FIG. 6C, a dry or previously dried elastic layer 24 can be brought to the lower side of the carrier plate 20, in order to provide a ready-to-use gripping device 14 after it has been fixed to the carrier plate 20 according to FIG. 6D. The moisture layer 24, which is loaded with low moisture, is illustrated graphically in FIGS. 6C and 6D in each instance by the lighter shade.

Optionally, with all of the embodiment variants shown, the drying device 32 can be equipped with or coupled to the collecting device 34 shown in FIG. 2C for collecting and discharging the water 38 removed from the layer 24. Thus, this applies not only to the variant shown in FIG. 2A to 2C, but possibly also to the variant shown in FIGS. 3A and 3B and also optionally to the variants shown in FIG. 4A to 4D. The variant with the rotatable roller 52 shown in FIG. 5A to 5C can also be equipped with a collecting device 34 in accordance with FIG. 2C.

In addition, at least one humidity sensor 56 can optionally be assigned to the layer 24 in all the variants shown, which humidity sensor is coupled to a control device 58 or supplies its output signals 60 to the control device 58, which in turn controls and activates the drying device 32 in different ways, depending on the embodiment variant, i.e., as required.

The schematic view of FIG. 3B shows by way of example such a configuration with a humidity sensor 56 assigned to the air-guiding and air-permeable layer 24, the output signals 60 of which are made available to the control device 58, which in turn controls the electric power supply 42 for activating the electric heater 46 integrated in the carrier plate 20 as soon as the layer 24 is loaded with an undesired amount of condensed moisture.

However, such a configuration, as shown by way of example in FIG. 3B, can also be provided with the embodiment variant of the apparatus 10 shown in FIGS. 2A to 2C, even if the humidity sensor 56 and the control device 58 are not shown graphically there. Similarly, this configuration can be provided in a corresponding manner with the embodiment variant of the apparatus 10 shown in FIG. 3A, even if the humidity sensor 56 and the control device 58 are not shown graphically there.

Furthermore, a corresponding configuration can also be provided with the embodiment variant of the apparatus 10 shown in FIGS. 4A and 4B, even if the humidity sensor 56 and the control device 58 are not shown graphically there. If a moisture sensor 56 and a control device 58 evaluating its output signals 60 are provided therein, this controls the ejection process when the gripping device 14 is positioned on the support plate 48 and when the layer 24 is compressed, and possibly also the optional additional temperature control of the support plate 48 in accordance with FIGS. 4C and 4D.

Furthermore, a corresponding configuration can also be provided with the embodiment variant of the apparatus 10 shown in FIGS. 5A to 5C, even if the humidity sensor 56 and the control device 58 are not shown graphically there. If a moisture sensor 56 and a control device 58 evaluating its output signals 60 are provided therein, this controls the rolling of the gripping device 14 on the roller 52 and the compression triggered thereby of the layer 24.

Thus, the apparatus 10 comprises not only the drying device 32 shown in the different variants, but optionally also at least one sensor 56 allocated to the layer 24 and the control device 58 (or, if applicable, a control device) for moisture-dependent (depending on the sensor signals 60) activation of the drying device 32.

The at least one humidity sensor 56, which is optionally assigned in each instance to the layer 24 with all of the variants of the apparatus 10 according to the invention shown and which is preferably coupled to the control device 58 shown or supplies its output signals 60 to the control device 58, can also trigger other actions if this is desired or required in individual cases.

Thus, the control device 58 can, on the one hand, control and activate the drying device 32 in different ways as required on the basis of the output signals 60 of the humidity sensor 56, i.e., initiate the corresponding drying process. However, it is also conceivable if a fault message is derived from the output signals 60 and output by the control device 58 and/or transmitted to other units or machine modules (not shown here) coupled thereto. Such a fault message output by the control device 58 can serve as a reason for manual or machine-supported intervention by an operator or service personnel.

The schematic sectional views of FIGS. 7A and 7B show a preferred configuration of the elastically deformable and at least partially air-permeable layer 24, which in this case is a foam layer with an only partially open-pored or closed-pored structure, which is provided with numerous suction and air guide openings 62.

Preferably, a large number of such suction and air guide openings 62 can be provided in the layer 24, wherein typically the arrangement and the number of the suction and air guiding openings 62 to be provided and present can correspond to the number of articles 11 or empty cans 12 to be picked up and their positions within the grouping 26.

The air sucked in at the lower side of the suction surface 16 can thus pass through the suction and air guide openings 62 within the elastic layer 24 consisting of foam and flow largely unhindered directly through the air-guiding lines 30 and be sucked in by the negative pressure source 28, as soon as it is activated to pick up the articles 11 or empty cans 12 in the way shown in FIG. 7B.

Here, the articles 11 or empty cans 12 sucked in are preferably only in contact with the foam, which can ensure the sealing off of the respective suction and air guide openings 62 from the environment. Due to the deformability of the layer 24 formed from foam or other elastic materials, the desired sealing off can be ensured particularly well.

Thus, it can be clarified that the air-guiding layer 24 does not necessarily conduct the air sucked in through its structural set-up, as is the case with an open-pored foam structure without such suction and air guide openings 62, as shown in FIG. 7A and FIG. 7B, but that, depending on the embodiment variant, only the suitably arranged and suitably formed suction and air guide openings 62 can represent the air-guiding elements within the layer 24.

With the variant of the apparatus 10 according to the invention illustrated in FIGS. 7A and 7B, the foam structure of the layer 24 thus does not directly form the air-guiding layer 24, but has primarily the task of accommodating the suction and air guide openings 62 and, in addition, the task of preventing or at least limiting the suction of false air, which could flow through gaps between the articles 11 or empty cans 12 and the suction surface 16, if and as soon as the articles 11 or empty cans 12 to be picked up are in contact with the layer 24 (see FIG. 7B).

Thus, due to its elastic deformability and the large number of its suction and air guide openings 62, the layer 24 formed in this way is also particularly well suited for reliably picking up a large number of grouped articles 11 or empty cans 12, without the risk of incorrect suction with all its risks, for example due to individual articles 11 or empty cans 12 not being picked up or falling down.

All variants of the apparatus 10 according to the invention shown in FIGS. 2A to 6D can equally be equipped with a layer 24, which is formed, for example, by an open-pored foam with an air suction structure without such openings 62 in accordance with FIGS. 7A and 7B. Likewise, all of the variants of the apparatus 10 according to the invention shown in FIGS. 2A to 6D can optionally be equipped with such a layer 24 as last described above. Such a layer can, for example, be formed by an only partially open-pored or also by a closed-pored foam with an air suction structure with numerous openings 62 in accordance with FIGS. 7A and 7B.

Finally, it should be pointed out that the structure as described in FIGS. 7A and 7B using the example of an only partially open-pored or a closed-pored foam, can also be formed by an elastic layer 24 with the openings 62 shown, the elasticity of which is not created by a foam structure, but by the elastic material properties. Thus, it should be clarified at this point that the layer 24 can be formed by any elastic layer 24 having the suction and air guide openings 62 described and shown in FIGS. 7A and 7B.

In addition, such suction plate grippers, as described here using the gripping device 14 with reference to FIGS. 1A to 7B, can have valve controls that are not shown in detail here. Here, the air-guiding layer 24 can be assigned a larger number of valves, which can be formed by balls or freely movable valve bodies within the suction and air guide openings 62 or in the air lines 30 in the region of the contact plate located above. These balls or freely movable valve bodies can open the corresponding supply line to each of the suction and air guide openings 62 as soon as the negative pressure generated by the negative pressure source 28 is applied there.

Such a valve control can offer the additional advantage that only those suction and air guide openings 62 are activated where there is actually a product to be sucked in (article 11 or e.g., empty can 12). If this is the case, the valve remains open due to the suction force exerted by the negative pressure. If, on the other hand, the particular suction and air guide opening 62 is unoccupied because there is no product to be sucked in at this point, the valve can close and air is prevented from being sucked in there unnecessarily and the negative pressure system is prevented from conveying air unnecessarily.

The arrangement and respective number of the suction and air guide openings 62 present with the embodiment variant according to FIGS. 7A and 7B and the optional valves depends on the size and number of objects to be sucked in. For larger packaging units that are to be picked up with the gripping device 14, the suction and air guide openings 62 can also be arranged differently or, if applicable, also made larger in diameter.

As a purely precautionary measure, it should be pointed out once again at this point that the apparatus 10 is also capable of picking up articles 11 other than the empty cans 12 shown and described by way of example by the gripping device 14. Therefore, if reference is made to empty cans 12 at any point in this description, this term can in principle also be replaced by other terms, for example by the following terms: piece good, article, container, can, beverage can, flat packaging sheet or packaging blank, etc. Such a shift or modification of terms does not in any way affect or alter the statements regarding the nature of the present invention.

These statements apply equally to each of the following claims.

The invention has been described with reference to a preferred embodiment. However, it is conceivable for a person skilled in the art that modifications or changes can be made to the invention without departing from the scope of protection of the following claims.

### LIST OF REFERENCE SIGNS

10 apparatus, handling apparatus
11 article
12 empty can
14 gripping device
16 suction surface
18 provisioning station
20 carrier plate
22 suspension, suspension on the upper side
24 layer, air-permeable layer, air-guiding layer
26 grouping
28 negative pressure source
30 line, air-guiding line
32 drying device
34 collecting device
36 collecting basin
38 liquid, removed liquid
40 heating wires, electric heating wires
42 energy supply, electric energy supply
44 water vapor, escaping water vapor
46 heating, integrated electric heating (carrier plate)
48 support plate
50 heating, integrated electric heating (support plate)
52 roller, cylindrical roller
54 exchange station
56 humidity sensor
58 control device
60 sensor signals
62 suction and air guide openings

1. An apparatus (10) for handling articles (11) comprising:
a gripping device (14) with a suction surface (16) that can be subjected to negative pressure, wherein the suction surface (16) comprises a layer (24) that is elastically deformable and is air-permeable, at least in some regions; and
a drying device (32) that can interact with the layer (24) to remove moisture from the layer (24).

2. The apparatus (10) of claim 1, wherein the drying device (32) has a blowing device that can be coupled to the suction surface (16) for blowing air out of the layer (24).

3. The apparatus (10) of claim 1, wherein the drying device (32) is integrated into the layer (24).

4. The apparatus (10) of claim 3, wherein the drying device (32) comprises electric heating wires (40), which run within the layer (24).

5. The apparatus (10) of claim 1, wherein the drying device (32) comprises a heatable carrier plate (20), to which the layer (24) is fastened on a lower side of the heatable carrier plate (20).

6. The apparatus (10) of claim 1, wherein the drying device (32) comprises a support plate (48), against which the layer (24) can be pressed.

7. The apparatus (10) of claim 6, with which the support plate (48) can be temperature adjusted.

8. The apparatus (10) of claim 1, wherein the drying device (32) comprises a rotatable roller (52) which can be rolled against the layer (24).

9. The apparatus (10) of claim 1, wherein the drying device (32) comprises an exchange station (54) capable of detaching the layer (24), loaded with moisture, from the carrier plate (20) and exchanging it for a dry layer (24).

10. The apparatus (10) of claim 1, wherein the drying device (32) comprises a collecting device (34) for collecting and discharging water (38) removed from the layer (24).

11. The apparatus (10) of claim 1, the layer (24) further comprising at least one moisture sensor (56), which supplies output signals (60) to a control device (58) that can control and activate or deactivate the drying device (32) as desired.

12. The apparatus (10) of claim 1, wherein the layer (24) comprises a plurality of suction and air guide openings (62).

13. A method for regenerating a suction surface (16) of a gripping device (14), which can be subjected to negative pressure, in order to suck in and grasp a plurality of articles (11) on a lower side, in that the plurality of articles (11) are sucked into an elastically deformable and air-permeable layer (24) when negative pressure is applied, the method comprises removing moisture from the layer (24) with a drying device (32).

14. The method according to claim 13, wherein the removing moisture step comprises compressing the layer (24) against a support plate (48) or compressing the layer (24) with rotatable roller (52).

15. The method of claim 13, wherein the moisture removing step comprises applying positive air pressure to the layer (24).

16. The method of claim 13, wherein the moisture removing step comprises applying heat to the layer (24) through electric heating wires (40).

17. The method of claim 16, wherein the electric heating wires (4) run within the layer (24) or are structurally integrated into the layer (24).

18. The method of claim 13, wherein the moisture removing step comprising heating a heatable carrier plate (20), to which the layer (24) is fastened on a lower side.

19. The method of claim 13, wherein the moisture removing step comprises detaching a moisture-loaded layer (24) with a dry layer (24).

20. The apparatus (10) of claim 12, wherein the plurality of suction and air guide openings (62) are arranged in a regular grid on the layer (24).
